(19) United States
(12) Patent Application Publication
(10) Pub. No.: US 2025/0156488 A1
(43) Pub. Date: May 15, 2025

(54) DETERMINATION OF USER POST ITEMS RELATED TO SEARCH CONTENT USING CREATOR CONTEXT DATA

(71) Applicant: Google LLC, Mountain View, CA (US)

(72) Inventors: Spurthi Amba HOMBAIAH, London (GB); Marc Alexander NAJORK, Palo Alto, CA (US); Michael BENDERSKY, Cupertino, CA (US); Mingyang ZHANG, San Jose, CA (US); Tao CHEN, San Mateo, CA (US); Md Tanvir Al AMIN, San Jose, CA (US); Matt COLEN, San Francisco, CA (US); Vladimir OFITSEROV, Foster City, CA (US); Sergey LEVI, Palo Alto, CA (US)

(73) Assignee: Google LLC, Mountain View, CA (US)

(21) Appl. No.: 18/509,822

(22) Filed: Nov. 15, 2023

(51) Int. Cl. G06F 16/9535; G06Q 50/00

(52) U.S. Cl. CPC G06F 16/9535; G06Q 50/01

(57) ABSTRACT

Implementations described herein relate to determining user post items related to search content using user context data. In some implementations, a computer-implemented method includes inputting search content to a first content encoder to generate a first embedding that semantically represents the search content. A plurality of user post items and a plurality of associated creator context data items are input to one or more second content encoders to generate a corresponding plurality of second embeddings that semantically represent the user post items and the creator context data items. A respective similarity measure is determined between the first embedding and one or more of the second embeddings, and a result set of user post item(s) are output that are associated with the highest similarity of the second embeddings to the first embedding.

### BACKGROUND

Various internet services present information items to users that are related or relevant to particular content or search queries of interest to users. For example, news publishers and aggregator services provide news articles and other information to users. These services may also serve or recommend user posts alongside such information, which may complement the articles. For example, a news publisher or news aggregator service may serve one or more news articles to a user and also provide a number of user posts that are related to subjects and topics discussed in the news articles. Such user posts can include text posts or other posts provided by users and published on a social networking service (e.g., Facebook®, Twitter® or X, etc.), public forums and websites, or other sources of published user posts, messages, etc. However, services may recommend user posts that are not particularly relevant, or that are not sufficiently reliable or authoritative.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, devices, and computer-readable media to determine user post items related to search content using creator context data. In some implementations, a computer-implemented method includes inputting search content to a first content encoder to generate a first embedding that semantically represents the search content, wherein the first content encoder includes a first trained machine learning model. The method includes inputting a plurality of user post items and a plurality of creator context data items associated with the plurality of user post items to one or more second content encoders to generate a corresponding plurality of second embeddings that semantically represent the plurality of user post items and the plurality of creator context data, wherein the one or more second content encoders each include at least one trained second machine learning model. A respective similarity measure is determined between the first embedding and one or more of the plurality of second embeddings, and a result set is determined and output that includes one or more of the plurality of user post items that are associated with the respective similarity measures indicating highest similarity of respective embeddings of the plurality of second embeddings to the first embedding.

Various features of the method are disclosed. For example, in some implementations, the input search content is a news article that includes news text content, the plurality of user post items are user content posts published on a social network and include post text content, and the creator context data items each include an indication of one or more characteristics of a creator of an associated user post item of the plurality of user post items. In some implementations, the characteristics of the creator for the creator context data items include a username or identifier of the creator, biographical information of the creator, an address of a website associated with the creator, and/or a geographical location of the creator. In some implementations, the search content is a search query, the plurality of user post items include a plurality of images or a plurality of videos posted to a social network, and each creator context data item is data describing one or more characteristics of a creator of an associated one of the plurality of images or the plurality of videos.

In some implementations of the method, the one or more second content encoders include a particular second content encoder, and inputting the user post items and the creator context data items to one or more second content encoders includes, for each pair of a user post item and an associated creator context data item: concatenating the user post item and the associated creator context data item to form a concatenated content item; and inputting the concatenated content item to the particular second content encoder to generate a respective second embedding of the corresponding plurality of second embeddings.

In some implementations of the method, the one or more second content encoders include a user content encoder and a creator context encoder, and inputting the user post items and the creator context data items to one or more second content encoders includes, for each pair of a user post item and an associated creator context data item: inputting the user post item to the user content encoder to generate a first intermediate embedding: inputting the creator context data item to the creator context encoder to generate a second intermediate embedding: concatenating the first intermediate embedding and the second intermediate embedding to form a concatenated embedding; and inputting the concatenated embedding to a combining neural network to generate a respective second embedding of the corresponding plurality of second embeddings.

In some implementations of the method, the respective similarity measure between the first embedding and each of the corresponding plurality of second embeddings is a respective resulting similarity measure, wherein the one or more second content encoders include a user content encoder and a creator context encoder, and wherein inputting the user post items and the creator context data items to one or more second content encoders includes, for each pair of a user post item and an associated creator context data item: inputting the user post item to the user content encoder to generate a user post embedding: determining a first similarity measure between the user post embedding and the first embedding: inputting the creator context data item to the creator context encoder to generate a creator context embedding: determining a second similarity measure between the creator context embedding and the first embedding; and combining the first similarity measure and the second similarity measure to form the respective resulting similarity measure.

In some implementations, a device includes a processor and a memory coupled to the processor. The memory may have instructions stored thereon that, when executed by the processor, cause the processor to perform operations that include the method steps described above. Some implementations provide a non-transitory computer-readable medium with instructions stored thereon that, when executed by a processor, cause the processor to perform operations that may be similar to one or more steps or elements described above for the method and/or device.

### BRIEF DESCRIPTION OF THE DRAWINGS

FIG. 1 is a block diagram of an example network environment which may be used for one or more implementations described herein.

FIG. 2 is a block diagram illustrating a first example system to determine user post items related to search content using creator context data, according to some implementations.

FIG. 3 is a block diagram illustrating a second example system to determine user post items related to search content using creator context data, according to some implementations.

FIG. 4 is a block diagram illustrating a third example system to determine user post items related to search content using creator context data, according to some implementations.

FIG. 5 is a flow diagram illustrating an example method to determine user post items related to search content using creator context data, according to some implementations.

FIG. 6 is a block diagram of an example computing device which may be used to implement one or more features described herein.

### DETAILED DESCRIPTION

In many contexts, such as search result pages, curated content pages, etc., it is useful to include content such as user generated content, e.g., social media posts, comments on a news article, images or video content, etc. to provide a richer user experience. For example, a news article (e.g., an article about a football game) may include user posts related to the topic of the article (e.g., user posts discussing the game). However, identifying user generated content that is relevant and of high quality is difficult. Social media posts and comments are often relatively short in length and devoid of context. For example, the post “Longest goal ever!” about an ice hockey game lacks the context to interpret that it is related to a particular game, or even to ice hockey, since soccer and other sports also involve scoring goals from a distance.

The present specification describes techniques to incorporate creator context in interpreting a user post to determine relevance to content. For example, such creator context may be based on creator identity and expertise (e.g., “soccer coach,” “business journalist,” “human rights activist,” etc.), creator location, or other factors. Machine learning models are trained to generate embeddings or vector representations from user posts taking into account the creator context. The embeddings can be compared with content embeddings to identify matching user posts. By incorporating knowledge about the creator into the embeddings that are matched, the described techniques improve the automated understanding of user posts and can improve precision (quality of matching user posts to content).

In some implementations, the user post and creator context may be concatenated and a single embedding may be generated (early fusion) and compared with content embeddings. In some implementations, separate embeddings may be generated from the user post and the creator context and merged (intermediate fusion) prior to comparison with content embeddings. In some implementations, separate comparisons of embeddings of the user post and the creator context may be made with content embeddings and the results may be combined (late fusion) to rank user posts. Machine learning models may be trained to generate content embeddings and user post (with creator context) embeddings in the same embedding space to enable comparison.

In some implementations, a training dataset may include content articles and corresponding ground truth user posts and associated creator context as positive examples. For example, content articles may include (e.g., embed) the user posts, indicating that the user posts are highly relevant to the content article. Negative examples may be constructed by matching content articles with other (e.g., randomly selected) user posts. Supervised learning techniques may be utilized, e.g., to co-train models that generate content embeddings and user post (with creator context) embeddings, to encode into the same space such that positive examples are closer in vector space (cosine similarity) than negative examples. In effect, the training process configures the model parameters to generate content embeddings and user post embeddings that are closer in vector space when user posts and creator context is relevant to the content, and that are far apart in vector space when the user posts are not relevant to the content.

In some examples, the trained models can be used in production settings to automatically identify user posts relevant to content. In some implementations, content embeddings may be precomputed and cached. User post (and/or creator context) embeddings may be precomputed and cached. In some implementations, generation of user post embeddings may be performed periodically (e.g., once a minute, at 5-min intervals, etc.) to ensure fresh user posts are included. Alternatively, user post embeddings may be generated continuously as user posts are received. At the time of serving the content, e.g., serving a curated content page including content and relevant user posts, the cached content embeddings may be compared with user post embeddings to identify relevant user posts for serving. Relevant user posts may be ranked according to their similarity to the content. Alternatively, they may be re-ranked according to other properties of each user post, such as the popularity of the user post creator, the number of impressions the user post has received, the temporal proximity of the user post to the content, or the quality of the writing of the user post.

This specification relates to determining user post items (e.g., social media text posts, images, video content, audio content, etc.) related to search content (e.g., search queries and/or associated result pages) using creator context data about the creators of the user post items in addition to the content of the user post items. In some implementations, search content can include content data such as one or more articles (e.g., news articles, blog posts, etc.), other text content (e.g., descriptions, queries, summaries, etc.), or other types of content (e.g., videos, images, audio data). User post items are to be searched from sources available on publicly-accessible networks. Such user post items can include user posts or messages on social networking services, websites, webpages, or other internet sources, and/or other user-provided content such as user videos, images, audio data, etc. User post items related to the search content are determined, e.g., user post items that include or present topic(s) that are the same or similar to topics in the search content. The related user post items can be output, e.g., as recommended content items via an output device such as a display device.

Some described features include generating a dense representation (one or more embeddings) of user post items and creator context in a search content space as a co-embedding with an embedding of the search content, allowing the user post items to be effectively compared for relevancy to the search content. For example, described techniques can include inputting search content to a first content encoder to generate a first embedding that semantically represents the search content in multiple dimensions, inputting user post items and associated creator context data items to one or more second content encoders to generate corresponding second embeddings that semantically represent the user post items and the creator context data items. A respective similarity measure is determined between the first embedding and each of the corresponding second embeddings, and a result set is determined and output based on the similarity measure. For example, the result set can include user post item(s) that are associated with the highest similarity of the second embeddings to the first embedding. Various implementations allow the creator context data to be combined with the user post items prior to generating embeddings, or separate creator context embeddings can be generated and combined with user post embeddings and/or compared to search content embeddings for similarity.

Systems and techniques described herein use machine learning models to generate embeddings of the search content and the user post items and compare the embeddings to determine their similarity. As described herein, creator context items associated with the user post items are also included in embeddings and similarity measures to increase the accuracy or relevance of user post items with respect to the search content. Such creator context items can include characteristics of user creators of the user post items, such as user names, screen names, or other identifiers of the creators: biographical information of the creators: an address of websites or other published information associated with the creators: geographical locations of the creators: etc.

Retrieval of relevant and important user post items for particular search content (such as a news article) is valuable for many internet publishing services to provide a greater scope of related information to users, and can also be a useful tool for journalists and other writers. In some examples, when evaluating whether and how well a given user post item (e.g., user post) complements a news story, two factors to consider include 1) who the creator of the user post is with regard to the story and 2) what the user post says.

Some previous techniques may retrieve user posts from topic authorities for the topics of the news and select user posts that are relevant. However, methods for identifying topic authorities and for computing the topicality of user posts for a news story may provide results of low relevance. For example, the topic may be defined as a single topic for the story and the “authority” may be a metric computed based on the count of previous inclusions of user posts from the given author in documents with the topic. However, for broad topics, such as “San Francisco,” there may be hundreds of authorities, only a few of which may be relevant for a specific news story. In addition, previous techniques may rely on unigrams and bigrams in the user post to compare with news story terms, which provides limited relevancy.

Systems and techniques described herein can address these problems. Described features can improve on finding, retrieving, and providing relevant user post items for search content (such as a news article) by including a context of the creator of a user post item in the determination of relevancy of that user post item. Creator context refers to the information about the creator which may not be present in the user post item created by the creator. Grounding interpretation of a user post item in the context of its creator can play an important role in deciphering the true intent and importance of the user post item. For example, in a user post that mentions the pronoun “my,” it is difficult to tell who the author is, and what event this post relates to, from the post content alone without creator context. Knowing the creator is useful for understanding the authoritativeness and news-worthiness of the post, which may be beneficial for applications such as user content search and recommendation.

In some examples, the importance of creator context may be more pronounced on short-form user post items such as user posts, messages, etc. Techniques described herein use the context of the creator of a user post item to facilitate semantic understanding of the user post item and determine its relevance to search content such as a news article, text query, image or video query, etc.

Furthermore, the particular characteristics of creator context that are used in the retrieval process can also be advantageous, as in some implementations of the described systems and techniques. Previous or historical posts and other content items published by a user (creator) can potentially provide a relevant context for the user, but obtaining all of a user's historical content items may be technically impractical, especially at large scale and for real-time applications. Furthermore, the interests of users may change over time, requiring that recent content items be continually obtained and updated. Some implementations of described systems and techniques, in contrast, can limit the use of historical content items and can use more stable sources of creator context that can be obtained efficiently to approximate the long-term interest of a user. In addition, not all creator contexts are effective at indicating user interests, and creator context can be time sensitive and noisy. Selection of particular characteristics of creator context, and particular model structure design, can be effective in determining relevant user post items.

Some implementations of described systems and techniques provide a simple and effective way to obtain search content, user post items, and creator context, e.g., from public internet sites and services and user account metadata. The techniques can collect a large scale high-quality corpus of millions of news articles containing user content posts, without requiring expensive human annotation. The brevity of text in many user post items (e.g., less than 140 characters, less than 100 words, etc.) make the dense language model-derived embeddings as described herein suitable such that the techniques outperform token matching methods to determine similar topicality and relevance of user post items to search content.

Technical advantages of described features include reduction of processing resources and consumption of power resources on devices. Described techniques allow highly relevant user post items to be found and served to users, thus reducing consumption of processing, memory, and network resources that would otherwise be expended to find relevant content items over longer, more extensive, and more numerous search operations. In some implementations, described features allow use of stable creator context information to be used, thus avoiding the use of dynamic content such as previous user posts to determine a profile of the user which must be continually updated as users' interests shift over time, and thus removing or reducing the expenditure of processing resources for such updates.

Further to the descriptions herein, a user may be provided with controls allowing the user to make an election as to both if and when systems, programs, or features described herein may enable collection of user information (e.g., information about a user's content items, a user's context, a user's devices and device types, a user's preferences including for search topics or displaying retrieved user post items, a user's current location, or images, videos, or audio data), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

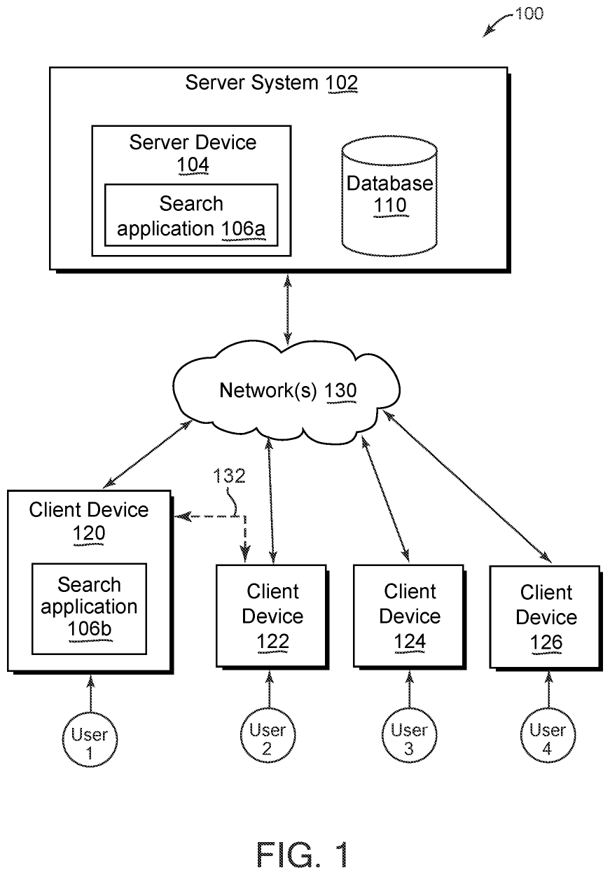

FIG. 1 illustrates a block diagram of an example network environment 100, in which some implementations described herein may be employed. Network environment 100 includes one or more server systems, e.g., server system 102 in the example of FIG. 1, and a plurality of client devices, e.g., client devices 120-126, each associated with a respective user of users U1-U4. Each of server system 102 and client devices 120-126 may be configured to communicate via a network 130.

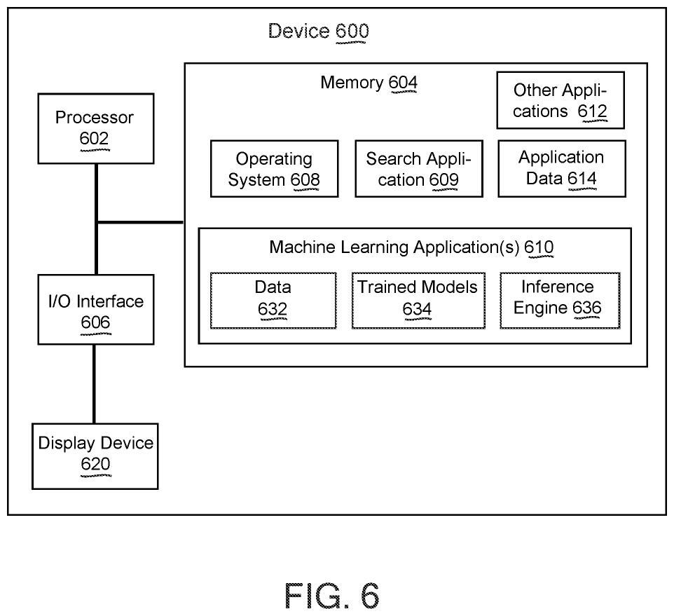

Server system 102 can include a server device 104 and a database 110. Server device 104 can include hardware and software processing components (e.g., as shown in FIG. 6, below) to perform relevance determination and retrieval tasks for user post items based on search content. In some implementations, server device 104 may provide search application 106a to perform such determination and retrieval tasks, or can communicate via networks 130 with other devices that perform such tasks and provide user post items. In FIG. 1 and the remaining figures, a letter after a reference number, e.g., “106a,” represents a reference to the element having that particular reference number. A reference number in the text without a following letter, e.g., “106,” represents a general reference to embodiments of the element bearing that reference number.

Database 110 may be stored on a storage device that is part of server system 102. In some implementations, database 110 may be implemented using a relational database, a key-value structure, or other type of database structure. While FIG. 1 shows a single database 110, it may be understood that database 110 may be implemented as a distributed database, e.g., over a plurality of database servers.

Database 110 may store user content data associated with user posts (such as user post items, including text content posts, images, videos, etc. from user posts), metadata associated with the user content data (e.g., creator context data), and one or more other database fields, stored in association with the user content data. In some implementations, database 110 can store embeddings of search content, user post items, and/or creator context items as described herein. Access permissions for database 110 may be restricted such that each user can control how their associated content data in database 110 may be accessed, e.g., by application 106, by other applications, and/or by one or more other users. Server system 102 may be configured to implement the access permissions, such that data of a particular user is accessible only as permitted by the user. In some implementations, database 110 may include a plurality of partitions, each corresponding to a respective library for each of users 1-4.

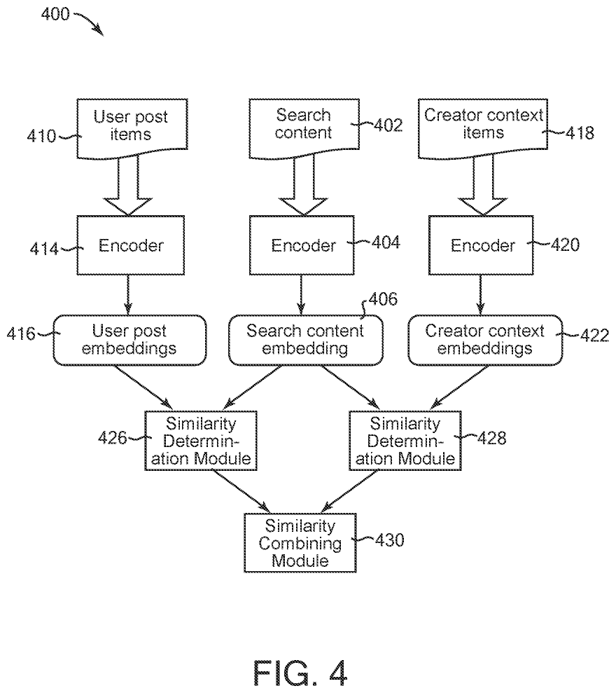

In some implementations, database 110 can be, or can include, a vector database for use in retrieving data for techniques described herein. For example, the vector database can store vectors of real numbers, and may allow only lookup operations (in contrast to relational databases that allow additional operations); e.g., when provided an input vector, the vector database returns the N vectors in store that are most similar to the input vector. In some example implementations, the techniques described herein can retrieve search content (e.g., news articles or other content) in response to a query using a vector database, or using an inverted index database; and user posts can be retrieved using a vector database. In some example implementations, creator context data can be retrieved using a simple key-value store (e.g., for implementations as in FIG. 3), or using a vector database (e.g., for implementations as in FIG. 4).

Network environment 100 can include one or more client devices, e.g., client devices 120, 122, 124, and 126, which may communicate with each other and/or with server system 102 via network 130. Network 130 can be any type of communication network, including one or more of the Internet, local area networks (LAN) such as WiFi networks, wide area networks (WAN) such as cellular networks, wireless networks, switch or hub connections, etc. In some implementations, network 130 can include peer-to-peer communication between devices, e.g., using peer-to-peer wireless protocols (e.g., Bluetooth®, Wi-Fi Direct, etc.), etc. One example of peer-to-peer communication between two client devices 120 and 122 is shown by arrow 132.

In various implementations, users 1, 2, 3, and 4 may communicate with server system 102 and/or each other using respective client devices 120, 122, 124, 126 and 140. In some examples, users 1, 2, 3, and 4 may interact with each other via applications running on respective client devices and/or server system 102 and/or via a network service, e.g., a social network service, news service, search engine, or other type of network service, implemented on server system 102 and/or other systems connected via networks 130. For example, respective client devices 120, 122, 124, and 126 may communicate data to and from one or more server systems, e.g., server system 102.

In some implementations, the server system 102 may provide appropriate data to the client devices such that each client device can receive served content or shared content determined by or uploaded to the server system 102 and/or a network service. In some examples, users 1-4 can interact via audio or video conferencing, audio or image data sharing, audio, video, or text chat, or other communication modes or applications.

A network service implemented by server system 102 can include a system allowing users to perform a variety of communications, form links and associations, view and post (e.g., upload) user post items such as content posts, messages, images (including videos), text, audio, and other types of content, and/or perform other functions. For example, a client device can display or otherwise output received data such as user content posts sent or streamed to the client device and originating from a different client device via a server and/or network service (or from the different client device directly), or originating from a server system and/or network service. In some implementations, client devices can communicate directly with each other, e.g., using peer-to-peer communications between client devices as described above. In some implementations, a “user” can include one or more programs or virtual entities, as well as persons that interface with the system or network.

In some implementations, any of client devices 120, 122, 124, and/or 126 can provide one or more applications. For example, as shown in FIG. 1, client device 120 may provide search application 106b. Client devices 122-126 may also provide similar applications. Search application 106a may be implemented using hardware and/or software of client device 120. In some implementations, search application 106 can be part of a larger application, e.g., a social networking service application or web interface, etc. In different implementations, search application 106a may be a standalone client application, e.g., executed on any of client devices 120-124, or may work in conjunction with image application 106b provided on server system 102.

Search application 106 may provide various features, implemented with user permission, that are related to content data processing. For example, features provided by search application 106 can include one or more of providing user interfaces to receive and execute search queries, output search results, etc. In some implementations, search application 106 includes additional features and/or is included in other applications or software. For example, a communications application (e.g., voice call application, chat application, video conference application, etc.) as processing of other types of data, e.g., text, images, video, etc.

In various implementations, with user permission, the features provided by search application 106 may include programmatically comparing search content to user post items to determine relevant user post items for the search content, using systems and/or techniques described herein. While the foregoing description refers to a variety of features of search application 106, it will be understood that in various implementations, search application 106 may provide fewer or more features. Further, each user is provided with options to enable and/or disable certain features.

Each client device 120-126 may include a database or other local storage, which may be a standalone database. In some implementations, the database may be usable in combination with database 110 on server system 102. For example, with user permission, database 110 and the local client databases may be synchronized via network 130. In some implementations, the database on client devices 120-126 may include a subset of data that is stored by database 110 on server system 102. For example, such implementations may be advantageous when a limited amount of storage space is available on client devices.

In different implementations, client device 120 and/or server system 102 may include other applications (not shown) that may be applications that provide various types of functionality, e.g., social networking (e.g., messaging or chat, audio/video calling, sharing images/video, etc.), communications with other devices, image, video, and audio capture and/or editing, calendar, address book, e-mail, web browser, shopping, transportation (e.g., taxi, train, airline reservations, etc.), entertainment (e.g., a music player, a video player, a gaming application, etc.), and so on. In some implementations, one or more of the other applications may be standalone applications that execute on a client device. In some implementations, one or more of the other applications may access a server system, e.g., server system 102, that provides data and/or functionality of the other applications.

A user interface on a client device 120, 122, 124, or 126 can enable the search and display of search content items (e.g., news articles, search queries, etc.), user post items, and other content, including text, audio content, images, video, and other content as well as communications, privacy settings, notifications, and other data. Such a user interface can be displayed using software on the client device, software on the server device, and/or a combination of client software and server software executing on server device 104, e.g., application software or client software in communication with server system 102. The user interface can be displayed by a display device of a client device or server device, e.g., a touchscreen or other display screen, projector, etc. In some implementations, application programs running on a server system can communicate with a client device to receive user input at the client device and to output data such as visual data, audio data, etc. at the client device.

In some examples, the user interface on a display device of a client device can display one or more search content items, such as news articles. The user interface can also display user post items that are relevant and related to the search content items (e.g., are related to one or more topics that are also in the search content items), which have been determined and retrieved using the techniques and systems described here.

For example, a news aggregator service can be provided by server 102, which can display a number of news articles related to a particular topic. These articles, for example, can be displayed in a first section or area of the user interface that indicates they are news articles from particular news websites or services. In a different section or area of the user interface (e.g., below or to the side of the first area), user post items can be displayed which are related to the particular topic, as determined by one or more techniques described herein. For example, the author and text of the user post items can be displayed, or image or video thumbnails corresponding to image or video user post items.

In another example, in some implementations, the user interface (e.g., on a client device) can display content that is in process of being composed or edited by a user (e.g., a text document, images, video, etc.), and the user can command the user interface to display and/or incorporate published user posts that are related to that content. The content can be provided as search content to a system (e.g., system 200, 300, or 400 described below) which determines related user posts. The determined user posts can be displayed in the user interface (e.g., as suggestions) and/or incorporated into or attached to the content being composed or edited, e.g., automatically or as instructed by the user.

For ease of illustration, FIG. 1 shows one block for server system 102, server device 104, database 110, and shows blocks for client devices 120, 122, 124, and 126. Server blocks 102, 104, and 110 may represent multiple systems, server devices, and network databases, and the blocks can be provided in different configurations than shown. For example, server system 102 can represent multiple server systems that can communicate with other server systems via the network 130. In some implementations, server system 102 can include cloud hosting servers, for example. In some examples, database 110 may be stored on storage devices provided in server system block(s) that are separate from server device 104 and can communicate with server device 104 and other server systems via network 130.

Also, there may be any number of client devices. Each client device can be any type of electronic device, e.g., desktop computer, laptop computer, portable or mobile device, cell phone, smartphone, tablet computer, television, TV set top box or entertainment device, wearable devices (e.g., display glasses or goggles, earbuds or headphones, wristwatch, headset, armband, jewelry, etc.), personal digital assistant (PDA), media player, game device, etc. In some implementations, network environment 100 may not have all of the components shown and/or may have other elements including other types of elements instead of, or in addition to, those described herein.

Other implementations of features described herein can use any type of system and/or service. For example, any of various networked services (e.g., connected to the Internet) can be used. Any type of electronic device can make use of features described herein. Some implementations can provide one or more features described herein on one or more client or server devices disconnected from or intermittently connected to computer networks. In some examples, a client device including or connected to a display device can process search content items, user post items, and creator context items stored on storage devices local to the client device, e.g., received previously over communication networks.

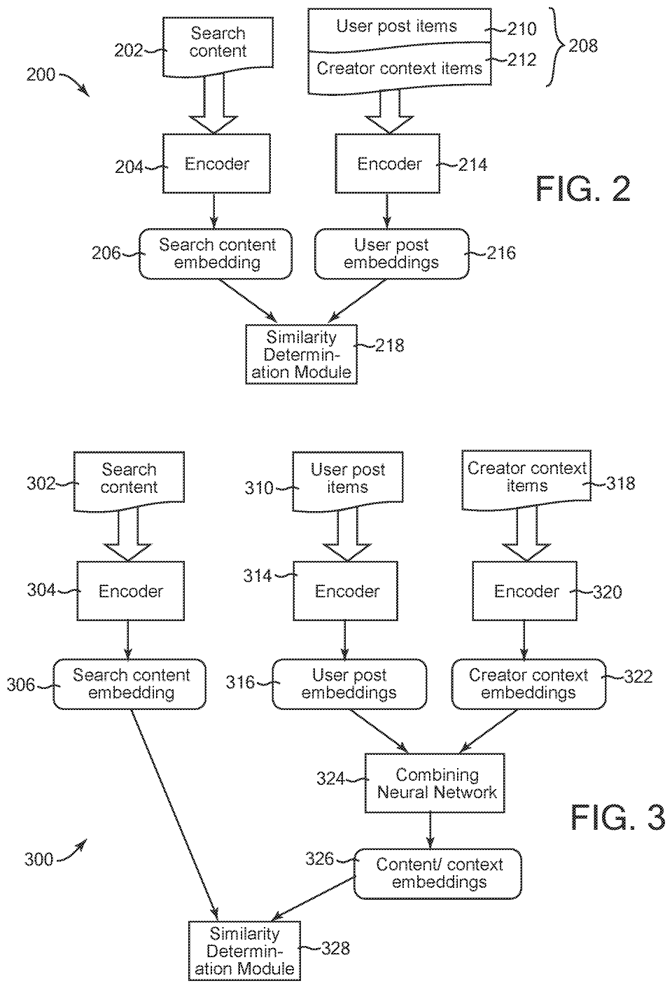

FIG. 2 is a block diagram illustrating a first example system 200 to determine user post items related to search content using creator context data, in accordance with some implementations. In some implementations, some or all of the system 200 can be implemented on one or more server devices, e.g., server system 102 of FIG. 1. In some implementations, system 200 can be implemented on one or more client devices 120, 122, 124, or 126 as shown in FIG. 1. In some implementations, system 200 can be implemented on both server device(s) and client device(s) (e.g., some components on a client device and some components on a server device). In some implementations, system 200 can be implemented by search application 106 of FIG. 1 and/or hardware components of a device that is executing application 106.

System 200 can include a search content encoder 204, a user content encoder 214, and a similarity determination module 218.

In this example, search content 202 is input to search content encoder 204. Search content 202 can be any content data that is used as a search query to find user post items that are semantically related to the search content 202. In some examples, search content 202 can be one or more text news articles or summaries that provide news stories that include one or more topics, which can be any topic such as politics, sports, business news, weather forecasts, entertainment news, science topics, etc.). In some implementations, search content 202 can be one or more articles from a publication, university, web pages, etc., or a summary or other text description describing one or more particular topics. In some cases, search content 202 can be multiple articles or other data items which have at least one topic in common between the articles or data items. In some examples, the search content can include search results from a search of internet content performed in response to receiving a search query, e.g., from a user. In some implementations, search content can be a text query input by the user, e.g., a question, phrase, or other collection of words. In some implementations, search content 202 can be or include other types of content, such as images, videos, audio data, etc. (e.g., an article that is provided as video, multiple images, or audio, etc., or a search query that is one or more images, video, audio data, etc.). In various implementations, search content 202 is one data item or can be multiple such data items (e.g., articles, summaries, videos, etc.). In some implementations, search content 202 can be content that is in process of being composed or edited by a user, e.g., where the user commands the content to be provided as search content to system 200 so that related user posts can be obtained from system 200 and included in the content being composed or edited. In some implementations, search content 202 can be a cluster of content items, e.g., a cluster of articles having the same topics, a cluster of images with similar depicted objects or pixel content, etc.

Search content encoder 204 is a machine learning model that has been trained to produce an embedding from input data. Search content encoder 202 has been trained based on training data that includes content items that are semantically similar and of the same content type as search content 202 (e.g., text, image, video, etc.). In some implementations, search content encoder 202 is a deep learning model, e.g., a Bidirectional Encoder Representation from Transformers (BERT) model (e.g., a BERT tower). An example of a BERT model is described in “BERT: Pre-training of deep bidirectional transformers for language understanding,” Devlin et al., arXiv preprint arXiv:1810.04805 (2018). Other types of machine learning models can be used in some implementations.

For example, in some implementations in which encoder 204 is trained on news articles as search content, encoder 204 can be a 12-layer BERT base model that is pre-trained on a large news dataset (e.g., millions of articles). In some implementations, news articles that include (e.g., embed) user post items such as user content posts (e.g., messages, tweets, videos, etc.) can be collected for training data, since such included content items are often carefully selected for inclusion in the article by the article author when composing the news article, and are thus relevant to the news article. For example, a large scale high-quality corpus of millions of news articles that include embedded user posts can be collected, thus providing user post items for training that are relevant to the article without requiring expensive human evaluation or annotation. In some implementations, the collected dataset of training data may contain the news articles and included (embedded) user post items as positive pairs, and in-batch negative training examples (other user post items that are unrelated) can be used for model training.

In some implementations, user post items may not be included or embedded in search content as in the case above of search content articles having embedded user text posts. For example, in some implementations, the search content may be a search query (e.g., text phrase, image, etc.). In some implementations, user post items may have been selected by users in search results for that search query, and these selected user post items can be used as positive training examples for that search query.

In some examples, for search content encoder training data, each collected news article title and body text can be concatenated, any included user post items are removed from the article, and the concatenated text can be tokenized using a tokenizer, including segmenting word sequences into a number of wordpiece tokens (e.g., using a wordpiece model). In some implementations, the encoder model can be optimized with sigmoid cross entropy loss and in-batch loss. In some implementations, the parameters of encoder 204 can be frozen, as the pre-trained checkpoint may be well-trained on the search content type of data (e.g., news documents) (e.g., no fine-tuning of parameters is performed), and other implementations can perform fine tuning of encoder 204. Hyperparameters can be tuned for the encoder 204, including learning rate, batch size and number of training steps on a development set of training data. Other parameters and search content can be used in some implementations.

Search content encoder 204 produces a search content embedding 206, which is a multi-dimensional vector representation of the search content 202. For example, in some implementations, search content embedding 206 is a CLS (classification) embedding from the top BERT layer of encoder 204. In some implementations, e.g., for published search content such as a news article, search content embedding 206 can be pre-computed and be available at serving time.

User content encoder 214 receives combined user content 208 as input. Combined user content 208 can be derived from user post items provided by users of social network services, online forums, websites, or other online public sources, such as user posts, messages, comments, or other content. Combined user content 208 includes user post items that are retrieval candidates which can be compared to search content 202 and from which are selected relevant user post items for presentation. For example, combined user content 208 can be based on text messages posted in a social networking service (that may include functionality such as friending users, following other users, etc.). In some implementations, combined user content 208 can be based on other content types, such as images, videos, or audio data posted or published by users. In some implementations, the set of user content 208 that is input to encoder 214 can be restricted by one or more criteria or filters. For example, user content 208 can be restricted to user post items that were posted or published within a threshold time period (e.g., one week) of the publication date (or latest or average publication date) of the search content 202 in cases where search content 202 is published data (e.g., one or more news articles).

Combined content items 208 include user post items 210 and associated creator context items 212. User post items 210 include the content portion, e.g., the body and title, of posted user post items (e.g., without metadata), such as the text (body and title) of a post or message, image pixel data, audio data output to create sound, etc.

Creator context items 212 include context information that can include, for each content item 210, one or more characteristics of the creator(s) of the associated user post item, such as the user that created (e.g., wrote, generated, or otherwise authored), posted, and/or published the associated user post item 210. In some implementations, the context information can be obtained as metadata of a user who created the associated user post item. For example, on social networking services, websites and video channels, etc., a user may have published context information about the user. In some implementations, creator context information can be provided as metadata of the associated user post item (e.g., a user text message or other uploaded item such as video, image, etc.) and be referenced or stored with the user post item content portion.

The creator characteristics that are included in creator context items 212 can be any of a variety of characteristics. For example, creator characteristics related to topics in associated content items can be included. In some examples, the creator characteristics included in creator context items 212 can include a user name or identifier of the creator. The user name can be a screen handle for the creator, a display name of the creator as seen on their profile, messages, or webpage, etc. Other creator characteristics can include biographical information of the creator (e.g., a description in the creator's profile on a social networking service), an address (e.g., Uniform Resource Locator (URL)) of a website associated with the creator (which may encode related information about the creator), a geographical location of the creator, etc.

In some implementations, other creator characteristics that are typically not related to such topics can be omitted from creator context items 212. For example, in some implementations, the number of follower users of the creator on a social networking service (and/or the number of users that the creator follows) can be omitted from creator context items 212. In some implementations, these follower/following creator characteristics can be included in the creator context items 212.

In some implementations, previous content posts created by the creator can be omitted from creator context items 212, because such posts can cover a broad range of diverse topics, because such posts can be very large in number and are expensive in processing, network, and time resources to obtain, and/or because creators are actively generating new content posts and their interests may shift over time such that retrieval of recently-created user post items may continually be needed to keep creator context items up to date. Thus, previous posts may be burdensome to obtain and to use to retrain the machine learning models. In contrast, the creator context information included in creator context items 212 as described above may be more stable over time, e.g., such that more recent creator context items do not need to be continually or frequently obtained. In some implementations, previous creator content items can be obtained and included in creator context items 212, e.g., previous content posts that match the time frame of the publication of the search content 202, e.g., within a threshold time period (e.g., previous user post items posted within one week of a news article publication date)

The characteristics that can be included in the creator context data can include additional and/or different characteristics. For example, the set of historic posts created by the creator is one example characteristic that can be included in some implementations as described above. A reading history of the creator (if available and with user permission), indicating content data and posts viewed by the creator, can be included as a context characteristic in some implementations, e.g., to estimate the creator's knowledge or expertise of particular subjects and to use the user's expertise to contextualize new posts.

In some implementations, a creator context item 212 can be specified by combining each creator characteristic of a user post item with a prefix (“screen”, “display”, bio”, “website”, “location” respectively) to create one text sequence.

User content encoder 214 is a machine learning model that has been trained to produce an embedding from input data. User content encoder 214 has been trained (including fine-tuned) based on training data that includes user post items that are semantically similar and of the same content type as combined content items 208 (e.g., text, image, video, etc.). In some implementations, user content encoder 214 is a deep learning model, e.g., a BERT model such as a BERT tower (similar to search content encoder 204) that has been fine tuned using combined content items 208. Other types of machine learning models can be used in some implementations.

For example, in some implementations in which user content encoder 214 is trained to process user post items such as user text posts and messages, encoder 214 can be a 12-layer BERT base model that is pre-trained on a large dataset of user post items (e.g., millions of user posts). In some implementations, the user content posts used to train encoder 214 are embedded in, and extracted from, the news articles of the training dataset for encoder 204 (as described above for some implementations). The creator context items used for training can be obtained from user accounts, the associated user post items, etc., as described above. In some implementations, the collected dataset of training data may contain the news articles and included (embedded) user post items as positive pairs, and in-batch negative training examples can be used for model training. For example, for a particular news article and included user post item positive pair sample, negative datapoints can include other user post items which are present in the collected batch of samples and which are not included in that news article. In some implementations, negative datapoints can include different user post items posted from the same creator that are more distant in time than the user post item included in the news article, and/or can include unrelated user post item(s) from one or more different creators. In some implementations, negative datapoints can include randomly-selected user posts.

In some examples for user text posts, for each user post item, intact tokens can be extracted from hashtags and user mentions in the user post item (e.g., split by camelcase and underscore, and/or by using a dictionary of unigrams constructed from n-grams to maximize probability of segmentation) and then a tokenizer can be applied to the user post item to segment word sequences into a number of wordpiece tokens (e.g., using a wordpiece model).

In some implementations, similarly to encoder 204, the training dataset for encoder 214 may contain positive pairs of news article and user post included in the news article, and in-batch negatives. The model can be optimized with sigmoid cross entropy loss and in-batch loss. In some implementations, the parameters of encoder 214 can be fine-tuned. Hyperparameters can be tuned for encoder 214, including learning rate, batch size and number of training steps on the set of training data. Other parameters and search content can be used in some implementations.

In some implementations, encoder 214 can be co-trained with encoder 204. For example, feedback generated to update the parameters of encoder 204 can be received by both encoders 214 and 204, such that both encoders receive the feedback and the training is performed simultaneously, e.g., in one cycle. Co-trained encoders can encode their inputs into the same embedding space such that positive examples are closer in vector space than negative examples. In effect, the training process configures encoder parameters of encoders 204 and 214 to generate content embeddings and user post embeddings that are closer in vector space when user posts and creator context are relevant to search content, and that are further apart in vector space when the user posts are not relevant to search content.

In some implementations, for the training data and for the inference stage shown in FIG. 2, a respective user post item (such as user post item 210) and associated creator context item (such as a creator context item 212) are combined into combined content (such as combined content 208) by concatenating the text of the content item and the text of the associated creator context as one single input sequence for the encoder 214 (e.g., BERT tower). This allows a cross attention mechanism of encoder 214 to model the interaction between a user post item and its creator context and generate a creator-aware content item embedding 216. In some implementations, this model may be computationally expensive, e.g., if the creator context is to be appended to each candidate content item.

User content encoder 214 produces user post embeddings 216, where each embedding 216 is determined from a set of user post items 210 (e.g., content portion) and associated creator context items 212. Each user post embedding 216 is a multi-dimensional vector representation of the combined user post item 210 and associated creator context item 212 from which it was determined by encoder 214. For example, in some implementations, each user post embedding 216 can be a CLS embedding from the top BERT layer of encoder 214.

Similarity determination module 218 receives search content embedding 206 and each user post embedding 216 and determines a respective semantic similarity measure (or score) between the search content embedding 206 and each embedding 216. In some implementations, cosine similarities are determined, which indicate the semantic relevance between the search content 202 and a user post item 210. Some implementations can use other forms of similarity determination, e.g. Euclidean similarity, dot product similarity, etc. As referred to herein, “similarity measure” or “similarity score” refers to the closeness in vector space of the respective embeddings that are compared for similarity, and not similarity of content data such as words, image pixels, etc. For example, a user post of “longest field goal ever; go 49ers!” may have high similarity in vector space with a news article about a 49ers football game, even if the article does not mention that the field goal was “longest ever.”

In some implementations, after similarity measures are determined, similarity determination module 218 or other component of system 200 (or other connected system) can perform a nearest neighbor search (or other proximity search) to determine the top number (N) user post embeddings that score highest, e.g., are most similar to search content embeddings 206. In some implementations, the top number N, and/or other characteristics, can be used to rank user post embeddings 216 for similarity to search content embedding 206. For example, one or more user post items 210 most relevant (similar) to search content 202 can be determined and output or otherwise served to a client device or other device (including other information about the user post item such as the creator name or other creator identifier, date of publication of the user post item, etc. in some implementations).

FIG. 3 is a block diagram illustrating a second example system 300 to determine user post items related to search content using creator context data, in accordance with some implementations. In some implementations, some or all of the system 300 can be implemented on one or more server devices, e.g., server system 102 of FIG. 1. In some implementations, system 300 can be implemented on one or more client devices 120, 122, 124, or 126 as shown in FIG. 1. In some implementations, system 300 can be implemented on both server device(s) and client device(s) (e.g., some components on a client device and some components on a server device). In some implementations, system 300 can be implemented by search application 106 of FIG. 1 and/or hardware components of a device that is executing application 106.

System 300 can include a search content encoder 304, a user content encoder 314, a creator context encoder 320, a combining neural network 324, and a similarity determination module 328.

In this example, search content 302 is input to search content encoder 304. Search content 302 can be any content data that is being used as a search query to find user post items that are semantically related to the search content 302, similarly as described above for search content 202 of FIG. 2. Search content encoder 304 is a machine learning model (such as a deep learning model, e.g., a BERT model, etc.) that has been trained to produce an embedding from input data and can be similar to search content encoder 204 of FIG. 2. Search content encoder 304 produces a search content embedding 306, which is a multi-dimensional vector representation of the search content 302 and can be similar to search content embedding 206 of FIG. 2.

User post items 310 are input to user content encoder 314. User post items 310 can be provided by users of social network services, online forums, websites, or other online public sources, and can be similar to user post items 210 as described above for FIG. 2. User post items 310 include the content portion, e.g., the body and title, of posted user post items (without metadata), such as the text (body and title) of a post or message, image pixel data, audio data output to create sound, etc.

User content encoder 314 is a machine learning model that has been trained to produce an embedding from input data such as user post items 310. User content encoder 314 has been trained (including fine-tuned) based on training data that includes user post items that are semantically similar and of the same content type as user post items 310 (e.g., text, image, video, etc.). In some implementations, the user content posts used to train encoder 314 are included in the news articles of the training dataset for encoder 304 (as described above for some implementations). In some implementations, user content encoder 314 can be a deep learning model (such as a BERT model, etc.) or other type of machine learning model similar to user content encoder 214 described above for FIG. 2. For example, encoder 314 can be similar to encoder 304 that has been fine tuned using user post items 310.

User content encoder 314 produces user post embeddings 316, where each embedding 316 is determined from a particular content item of input content items 310. Each user post embedding 316 is a multi-dimensional vector representation of the user post item 310 from which it was determined by encoder 314. For example, in some implementations, each user post embedding 316 is a CLS embedding from the top BERT layer of encoder 314.

Creator context items 318 are input to creator context encoder 320. Each creator context item 318 can include user characteristics of a creator of an associated user post item 310, e.g., obtained as metadata of a user account and/or of the associated user post item. Creator context items 318 can be similar to creator context items 212 as described above for FIG. 2.

Creator context encoder 320 is a machine learning model that has been trained to produce an embedding from input data such as creator context items 318. Creator context encoder 320 has been trained (including fine-tuned) based on training data that includes creator context data items that are semantically similar and of the same content type as creator context items 318 (e.g., text, image, video, etc.). In some implementations, the creator context items used to train encoder 320 can be associated with the creators of the user post items included in the news articles of the training dataset for encoder 304 (as described above for some implementations). In some implementations, creator context encoder 320 can be a deep learning model (e.g., a BERT model, etc.) or other type of machine learning model similar to user content encoder 214 or 314 described above. For example, encoder 320 can be similar to encoder 304 that has been fine tuned using creator context items 318.

In some implementations, two or more of encoders 304, 314, and 320 can be co-trained. For example, feedback generated to update the parameters of encoder 314 can be received by encoders 304, 314 and/or 320, such that multiple encoders receive the feedback and the training is performed simultaneously.

Creator context encoder 320 produces creator context embeddings 322, where each embedding 322 is determined from a particular creator context item of input creator context items 318. Each creator context embedding 322 is a multi-dimensional vector representation of the creator context item 318 from which it was determined by encoder 322. For example, in some implementations, each creator context embedding 322 is a CLS embedding from the top BERT layer of encoder 320.

In some implementations, each creator context embedding 322 can be determined on a per-creator basis. For example, if a user post item 310 has multiple creators, a respective creator context embedding 322 can be determined for each such creator.

In some implementations, one or more creator context items 318 and/or one or more creator embeddings 322 can be pre-computed based on creator context data, e.g., prior to system 300 receiving search content 302 and/or user post items 310. Embeddings of context information for some user content creators (e.g., commonly quoted creators in articles) can be computed in advance and stored, and retrieved for use in system 300 at the time that one or more user post items 310 created by those creators are input to system 300 (e.g., input to encoder 314). In some implementations, such embeddings can periodically be re-computed. Compared to the implementations of FIG. 2, in which creator context data is included in computing embeddings for each associated user post item at the time user post items 310 are to be input, the system 300 may help to significantly reduce computational cost. For example, popular creators' context embeddings only need to be computed once, not for each content item 310 of that creator and/or for different search content 302. In addition, decoupling computation of creator context embeddings from user post embeddings can enable the creator context embeddings 322 to be used as a separate ranking signal, and/or used separately in other applications, such as predicting creator similarities, matching creators to queries, etc. In some implementations, a pre-computed creator context embedding can be compared to the search content embedding for similarity without computing a user post embedding, which can allow the relevance of the corresponding user post item to the search content to be assessed via the similarity of the creator to the search content.

The user post item embeddings 316 and the associated creator context item embeddings 322 can be input to a combining neural network 324 of system 300. In some implementations, combining neural network 324 can be a fully connected layer. In some implementations, the combining neural network can be feed forward neural network (FFNN), or other type of model, e.g., a recurrent neural network, etc. Combining neural network 324 generates content-context embeddings 326, where a respective content-context embedding 326 is generated for each pair of user post item 310 and associated creator context item 318. Each content-context embedding 326 is a multi-dimensional vector representation of a user post item 310 and associated creator context item 318. Combining neural network 324 can project these embeddings 316 and 322 into an embedding space in which these items can be compared to the search content embedding 306.

Similarity determination module 328 receives search content embedding 306 and content-context embeddings 326 and determines a respective semantic similarity measure (or score) between each content-context embedding 326 and the search content embedding 306. In some implementations, cosine similarities are determined, which indicate the semantic relevance between the search content 302 and each of the pairs of user post item 310 and associated creator context item 318, and/or other similarity determinations can be made similarly as described above. In some implementations, the embeddings 316 and/or embeddings 322 may be clustered prior to being compared to embedding 306 for similarity, as similarly described above for system 200 of FIG. 2.

In some implementations, after similarity measures are determined, similarity determination module 328 or other component of the system 300 (or other connected system) can perform a nearest neighbor search (or other proximity search) to determine the top number (N) user post embeddings that score highest, e.g., are most similar to search content embeddings 206. In some implementations, the top number N, and/or other characteristics, can be used to rank content-context embeddings 326 for similarity to search content embedding 306. For example, one or more user post items 310 most relevant to search content 302 can be determined and output or otherwise served to a client device or other device.

In some implementations, user post items can be retrieved that have creators who have topic authority, e.g., creators whose context data is similar to particular search content (e.g., news articles) having a particular topic, such that the creator is often associated with search content having that topic. For example, a topic authority projection layer can be used that projects search content embedding 306 into the creator context embedding space of creator context embeddings 322. A similarity measure determined between these embeddings can be used to determine creators that have similarity to particular search content (e.g., topics). In some implementations, the creator context embedding space can be clustered and the creator context cluster can be indexed with associated user post items. At serving time, search content 302 can be matched to a creator context cluster (e.g., based on topic, and candidate user post items that have these creators can be obtained for input to encoder 314 since they are associated with the topic of the search content. In some implementations, the creator context data can include additional characteristics such as follower characteristics, e.g., the number of users following the creator on a social networking service. This may provide an indication of topical authority for a creator. For example, if a large number of users follow a creator, this may indicate that the creator has more authority for that topic because users follow other users who are interested in the same subjects. In some implementations, topical authority of a creator can be determined based on the number of times that the creator's user post items on a particular topic are included in content items (such as news articles).

FIG. 4 is a block diagram illustrating a third example system 400 to determine user post items related to search content using creator context data, in accordance with some implementations. In some implementations, some or all of the system 400 can be implemented on one or more server devices, e.g., server system 102 of FIG. 1. In some implementations, system 400 can be implemented on one or more client devices 120, 122, 124, or 126 as shown in FIG. 1. In some implementations, system 400 can be implemented on both server device(s) and client device(s) (e.g., some components on a client device and some components on a server device). In some implementations, system 400 can be implemented by search application 106 of FIG. 1 and/or hardware components of a device that is executing application 106.

System 400 can include a search content encoder 404, a user content encoder 414, a creator context encoder 420, a similarity determination module 426, a similarity determination module 428, and a similarity combining module 430.

In this example, search content 402 is input to search content encoder 404. Search content 402 can be any content data that is being used as a search query to find user post items that are semantically related to the search content 402, similar to search content 202 of FIG. 2 and search content 302 of FIG. 3. Search content encoder 404 is a machine learning model (e.g., a deep learning model such as a BERT model, etc.) that has been trained to produce an embedding from input data and can be similar to search content encoder 204 of FIG. 2 and/or search content encoder 304 of FIG. 3. Search content encoder 404 produces a search content embedding 406, which can be similar to search content embedding 206 of FIG. 2 and/or search content embedding 306 of FIG. 3.

User post items 410 are input to user content encoder 414. User post items 410 can be similar to user post items 310 as described above for FIG. 3. User post items 410 include the content portion, e.g., the body and title, of posted user post items (without metadata), such as the text (body and title) of a post or message, image pixel data, audio data output to create sound, etc.

User content encoder 414 is a machine learning model that has been trained to produce an embedding from input data such as user post items 410 and can be similar to user content encoder 314 described above for FIG. 3. User content encoder 414 produces multiple user post embeddings 416, where each embedding 416 is determined from a particular content item of input content items 410. User post embeddings 416 can be similar to user post embeddings 310 described above for FIG. 3.

Creator context items 418 are input to creator context encoder 420. Each creator context item 418 can include user characteristics of one or more creators of an associated user post item 410, and can be similar to creator context items 318 as described above for FIG. 3. Creator context encoder 420 is a machine learning model that has been trained to produce an embedding from input data such as creator context items 418 and can be similar to creator context encoder 320 described above for FIG. 3. Two or more of encoders 404, 414, and 420 can be co-trained similarly as described above for systems 200 and 300.

Creator context encoder 420 produces multiple creator context embeddings 422, where each embedding 422 is determined from a particular creator context item of input creator context items 418. Creator context embeddings 422 can be similar to creator context embeddings 322 described above for FIG. 3. In some implementations, creator context embeddings 422 can be determined on a per-creator basis, and/or can be pre-computed based on creator context data similarly as described above for creator context embeddings 322.

Similarity determination module 426 receives search content embedding 406 and user post embeddings 416 and determines a respective semantic similarity measure (or score) between each user post embedding 416 and the search content embedding 406. In some implementations, cosine similarities are determined similarly as described above for similarity determination module 218, which indicate the semantic relevance between the search content 402 and each of the user post items 410.

Similarity determination module 428 receives search content embedding 406 and creator context embeddings 422 and determines a respective semantic similarity measure (or score) between each creator context embedding 422 and the search content embedding 406. In some implementations, cosine similarities are determined similarly as described above for similarity determination module 218 or 328, which indicate the semantic relevance between the search content 402 and each of the creator context items 418. In some implementations, other similarity determinations can be made similarly as described above. In some implementations, embeddings 416 and/or embeddings 422 may be clustered prior to being compared to embedding 306 for similarity, as described above for system 200 or system 300. In various implementations, similarity determination modules 426 and 428 can be separate modules or can be parts or functions of a single module.

Similarity combining module 430 receives each similarity measure determined by similarity determination module 426 and receives the corresponding similarity measure determined by similarity determination module 428 and combines these similarity measures into a combined similarity measure. For example, combining module 430 can linearly combine the two similarity measures with a weight. In some implementations, the weight can be a learned model parameter. In some implementations, the learned weight may be biased toward creator context. In some implementations, the weight can be considered a hyperparameter and can be selected and/or tuned via grid search on the development set of search content items and user post items used for training the encoders of system 400.

Similarly to the system 300 of FIG. 3, system 400 can reduce the computational cost of creator context embeddings. The tuned weight can also provide a better interpretability to indicate the contribution from the user content encoder and creator context encoder. However, this model requires a similarity measure combining operation and may be less efficient in serving than some other implementations.

In some implementations, the combined similarity measures are used similarly to the similarity measure provided in system 200 or system 300 described above. For example, after combined similarity measures are determined for each pair of the search content with a respective user post embedding, a component of the system 400 (or other connected system) can perform a nearest neighbor search (or other proximity search) to determine the top number (N) user post embeddings that score highest, e.g., are most similar to search content embeddings 406. In some implementations, the top number N, and/or other characteristics, can be used to rank the content items and/or creator context items for similarity to search content 402 using the combined similarity measures. For example, one or more user post items most relevant to the search content 402 can be determined and output or otherwise served to a client device or other device.

In some implementations, based on the similarity measures from similarity determination module 426, the top N user post embeddings 416 can be determined that are most similar to the search content embedding (e.g., using a vector database). The creator context associated with each user post of the N user post embeddings is retrieved (e.g., using a key-value store). The creator context embeddings 422 can be determined via encoder 420 if they are not pre-computed. Similarity measures are determined for the search content and creator context embeddings (e.g., via module 428). The corresponding similarity measures from module 426 and module 428 are combined, e.g., in module 430, as described above, and the combined similarity measure is used as described above to determine the most relevant user post items.

In some implementations, creator context embeddings 422 can be determined from creator context items 418 and search content embedding 406 as described above (e.g., pre-computed). The top N creator context embeddings are determined that are most similar to the search content embedding (e.g., using a vector database). The top N user post embeddings are determined, that are created by the creators represented by the N creator embeddings, and that are the most similar to the search content embeddings (e.g., using a vector database). Similarity measures are determined for the pairs of search content and user post embeddings, similarity measures are determined for the pairs of search content and creator context embeddings, and the corresponding similarity measures are combined to obtain a combined similarity measure that is used similarly as described above to determine the most relevant user post items.

The complexity of the three implementations of systems 200, 300, and 400 may be different. Variables n and m can be used to denote the user post item and creator context item lengths, respectively. The best and worst case complexities for a system without use of creator context items (e.g., two encoders) is O(n²) and for the system 200 is O((n+m)²). For the systems 300 and 400, the worst case complexity is O(n²+m²) when the system is deployed and the best case complexity is O(n²) when the system has pre-computed embeddings for the creator context data after the system has been running for a sufficient period of time.

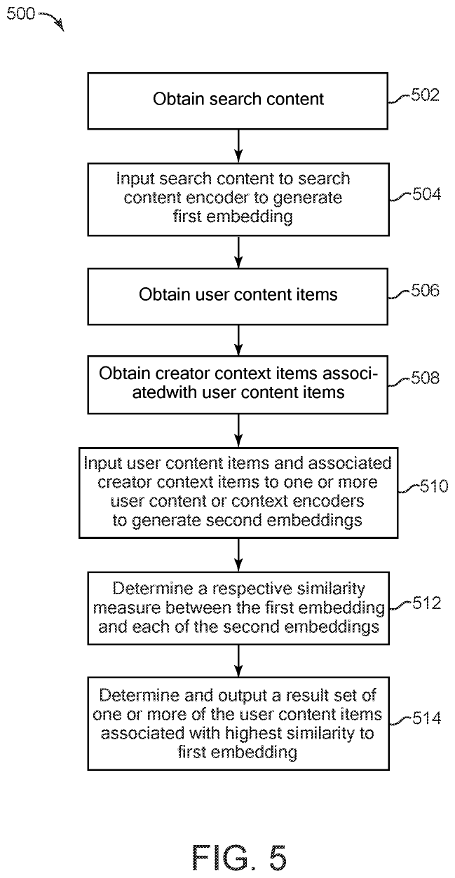

FIG. 5 is a flow diagram illustrating an example method 500 to determine user post items related to search content using creator context data, according to some implementations. In some implementations, method 500 can be implemented, for example, on one or more server systems 102 as shown in FIG. 1, or by one or more client devices 120, 122, 124, or 126 shown in FIG. 1. In some implementations, all or different portions of the method 500 can be implemented on server device(s) and client device(s). In described examples, the implementing system includes one or more digital processors or processing circuitry (“processors”), and one or more storage devices (e.g., a database or other storage). In some implementations, different components of one or more servers and/or clients can perform different blocks or other parts of the method 500. Some implementations can have one or more blocks of method 500 performed by one or more other devices (e.g., other client devices or server devices) that can send results or data to a first device that performs other blocks.

Method 500 may begin at block 502. In block 502, search content is obtained, which is to be used as a search query to find and present published user post items that are semantically relevant to the search content. Examples of search content can include news articles or other articles, summaries, reports, text phrases, images, videos, etc. As described herein, the user post items to be presented are to include and/or relate to one or more same or similar topics as in the search content. Block 502 may be followed by block 504.

In block 504, the search content is input to a search content encoder to generate a first embedding. As described herein, the search content encoder can be a machine learning model, e.g., a BERT model, that has been trained to generate an embedding from such content. Block 504 may be followed by block 506.

In block 506, user post items are obtained. In some implementations, user post items can include user posts and messages that have been published on the internet on an online social networking service. In some implementations, as described herein, the user posts and messages can include text, images, video, audio data, and/or other types of content data; and/or can be other forms of user-published content (e.g., images or videos in web pages or websites, etc.). Block 506 may be followed by block 508.

In block 508, creator context items are obtained, which are associated with the user post items of block 506. As described herein, the creator context items can include published or publicly-available characteristics of the creator users of the user post items, such as user names, geographic locations, biographical information, associated website addresses, etc. Block 508 may be followed by block 510.

In block 510, the user post items and associated creator context items are input to one or more user content and/or context encoders to generate second embeddings. As described for the various implementations of FIGS. 2-4, the user post items and creator context items can be combined and input to an encoder which generates embeddings, or can be input to separate encoders which generate separate embeddings. As described herein, the user content encoder and/or creator context encoder can be machine learning models, e.g., BERT models, that have been trained to generate an embedding from such input. In some implementations, one or more of the user post embeddings and/or the creator context embeddings may be computed periodically or continuously, and thus may be pre-computed and retrieved for use in method 500 without newly computing them, e.g., at the time of similarity comparison (block 512). Block 510 may be followed by block 512.

In block 512, multiple similarity measures are determined, where a respective similarity measure is determined between the first embedding and each of the second embeddings. As described above in the implementations of FIGS. 2-4, the second embeddings can be embeddings based on a combination of user post items and associated creator context items, can be embeddings combined from user post embeddings and creator context embeddings, or can be user post embeddings and creator context embeddings where each similarity measure is a combination of a first similarity measure between the first embedding and a user post embedding, and a second similarity measure between the first embedding and the associated creator context embedding. Block 512 may be followed by block 514.

In block 514, a result set of one or more of the user post items are determined and output. The user post items in the result set are associated with the highest similarities to the first embedding determined in block 512. Thus, the output user post items are the most similar or relevant to the search content, e.g., have the same or most similar topics. The result set of user post items can be transmitted to a client device over a network for display by the client device, can be stored in server or client storage devices, etc. Some examples of a user interface that can display the search content and result set of user post items are described above with reference to FIG. 1.

In various implementations, various blocks of method 500 may be combined, split into multiple blocks, performed in parallel, or performed asynchronously. In some implementations, one or more blocks of method 300 may not be performed or may be performed in a different order than shown in FIG. 5. Method 500, or portions thereof, may be repeated any number of times using additional inputs, e.g., additional search content and/or user post items are received.

FIG. 6 is a block diagram of an example device 600 which may be used to implement one or more features described herein. In some examples, device 600 may be used to implement a server device, e.g., server device 104 shown in FIG. 1. In some examples, device 600 may be used to implement a client device, e.g., any of client devices 120-126 shown in FIG. 1. In some implementations, device 600 may be used to implement a client device, a server device, or both client and server devices. Device 600 can be any suitable computer system, server, or other electronic or hardware device as described herein.

One or more methods and systems described herein can operate in several environments and platforms, e.g., as a standalone computer program that can be executed on any type of computing device, one or more server devices, a client application (e.g., mobile application (“app”) run on a mobile computing device such as a cell phone, smart phone, tablet computer, wearable device, laptop computer, etc.), etc. In one example, a client/server architecture can be used, e.g., a client device sends user input data to a server device and receives from the server the final output data (e.g., user post items that relate to search content or query and are to be output by a display device of the client device). In another example, computations can be split between the client device and one or more server devices.

In some implementations, device 600 includes a processor 602, a memory 604, and input/output (I/O) interface 606. Processor 602 can be one or more processors and/or processing circuits to execute program code and control basic operations of the device 600. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some implementations, processor 602 may include one or more co-processors that implement neural-network processing. In some implementations, processor 602 may be a processor that processes data to produce probabilistic output, e.g., the output produced by processor 602 may be imprecise or may be accurate within a range from an expected output. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 604 is typically provided in device 600 for access by the processor 602, and may be any suitable processor-readable storage medium, such as random access memory (RAM), read-only memory (ROM), Electrical Erasable Read-only Memory (EEPROM), Flash memory, etc., suitable for storing instructions for execution by the processor, and located separate from processor 602 and/or integrated therewith. Memory 604 can store software operating on the device 600 by the processor 602, including an operating system 608, search application 609 (e.g., which may be the same as search application 106 of FIG. 1), machine learning application(s) 610, other applications 612, and application data 614. Other applications 612 may include applications such as a data display engine, image editing applications, image display engine, notification engine, social networking engine, media display applications, communication applications, web hosting engines or applications, media sharing applications, etc. In some implementations, search application 609 and/or machine learning application(s) 610 can include instructions that enable processor 602 to perform functions described herein, e.g., some or all of blocks of system 200 of FIG. 2, system 300 of FIG. 3, and/or system 400 of FIG. 4, and/or operations of method 500 of FIG. 5. In some implementations, search content, user post items, one or more of the generated embeddings, and/or creator context items received from other devices can be stored as application data 614 or other data in memory 604, and/or on other storage devices of one or more other devices in communication with device 600.

Any of the software in memory 604 can alternatively be stored on any other suitable storage location or computer-readable medium. In addition, memory 604 (and/or other connected storage device(s)) can store one or more messages, user preferences, one or more taxonomies, electronic encyclopedia, dictionaries, digital maps, knowledge bases, grammars, and/or instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing device 600 with other systems and devices. Interfaced devices can be included as part of the device 600 or can be separate and communicate with the device 600. For example, network communication devices, storage devices (e.g., memory and/or database), and input/output devices can communicate via I/O interface 606. In some implementations, the I/O interface can connect to interface devices such as input devices (keyboard, pointing device, touchscreen, microphone, camera, scanner, sensors, etc.) and/or output devices (display devices, speaker devices, printers, motors, etc.). In some implementations, some hardware used for components of systems 200, 300, and/or 400 can be included in I/O interface 606 or other connected components of device 600.

Some examples of interfaced devices that can connect to I/O interface 606 can include one or more microphones that can be used to capture speech and other audio such that the speech and audio can be converted to input data (such as a search query) by the I/O interface 606 and other components of device 600. One or more speakers can output audio based on audio data. The I/O interface 606 can interface to other input and output devices.

One or more display devices 620 can be used to display content, e.g., images, video, and/or a user interface of an application. Display device 620 can be connected to device 600 via local connections (e.g., display bus) and/or via networked connections and can be any suitable display device. Display device 620 can include any suitable display device such as an LCD, LED, or plasma display screen, CRT, television, monitor, touchscreen, 3-D display screen, or other visual display device. Display device 620 may also act as an input device, e.g., a touchscreen input device. For example, display device 620 can be a flat display screen provided on a mobile device, multiple display screens provided in glasses or a headset device, or a monitor screen for a computer device.

In various implementations, machine learning application 610 may utilize Bayesian classifiers, support vector machines, neural networks, or other learning features and techniques. In some implementations, machine learning application 610 may include a trained model 634, an inference engine 636, and data 632. In some implementations, data 632 may include training data, e.g., data used to generate trained model(s) 634. For example, training data may include any type of data such as text, images, audio data, video, etc.

Training data may be obtained from any source, e.g., a data repository specifically marked for training, data for which permission is provided for use as training data for machine-learning, etc. In implementations where one or more users permit use of their respective user data to train a machine-learning model, e.g., trained model 634, training data may include such user data, e.g., user post items, creator context items, etc.

In some implementations, training data may include synthetic data generated for the purpose of training, such as data that is not based on user input or activity in the context that is being trained, e.g., data generated from computer-generated search content, user post items, and creator context items. In some implementations, machine learning application 610 excludes data 632. For example, in these implementations, the trained model 634 may be generated, e.g., on a different device, and be provided as part of machine learning application 610. In various implementations, the trained model 634 may be provided as a data file that includes a model structure or form, and associated weights. Inference engine 636 may read the data file for trained model 634 and implement a neural network with node connectivity, layers, and weights based on the model structure or form specified in trained model 634.

In some implementations, a trained model 634 can be a deep learning model such as a BERT model or similar model, and multiple such models can be used as described herein. In some implementations, a trained model 634 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a long short term memory (LTSM) network, a sequence-to-sequence neural network (e.g., a network that takes as input sequential data, such as words in a sentence, frames in a video, etc. and produces as output a result sequence), etc. The model form or structure may specify connectivity between various nodes and organization of nodes into layers.

For example, the nodes of a first layer (e.g., input layer) may receive data, e.g., data 632 or application data 614. Subsequent intermediate layers may receive as input output of nodes of a previous layer per the connectivity specified in the model form or structure. These layers may also be referred to as hidden layers or latent layers. A final layer (e.g., output layer) produces an output of the machine learning application. For example, the output may be an embedding of input data such as search content, user post items, or creator context items as described herein. In some implementations, model form or structure also specifies a number and/or type of nodes in each layer.

In different implementations, trained model 634 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in video or audio data, etc.

In some implementations, a trained model 634 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 632, to produce a result.

For example, training may include applying supervised learning techniques. In supervised learning, the training data can include a plurality of inputs (e.g., a set of search content samples or user post item samples) and a corresponding expected output for each input (e.g., a set of ground truth labels indicating embeddings). Based on a comparison of the output of the model with the expected output, values of the weights are automatically adjusted, e.g., in a manner that increases a probability that the model produces the expected output when provided similar input.

Machine learning application 610 also includes an inference engine 636. Inference engine 636 is configured to apply the trained model 634 to data, such as application data 614, to provide an inference. In some implementations, inference engine 636 may include software code to be executed by processor 602. In some implementations, inference engine 636 may specify circuit configuration (e.g., for a programmable processor, for a field programmable gate array (FPGA), etc.) enabling processor 602 to apply the trained model. In some implementations, inference engine 636 may include software instructions, hardware instructions, or a combination. In some implementations, inference engine 636 may offer an application programming interface (API) that can be used by operating system 610 and/or other applications 612 to invoke inference engine 636, e.g., to apply trained model 634 to application data 614 to generate an inference. For example, the inference for a user content retrieval model may be an embedding of a user post item in the embedding space of search content, allowing the user post embedding to be compared for similarity with a search content embedding as described herein.

Machine learning application(s) 610 may provide several technical advantages. For example, when trained model 634 is generated based on unsupervised learning, trained model 634 can be applied by inference engine 636 to produce knowledge representations (e.g., numeric representations) from input data, e.g., application data 614. For example, a model trained for a particular type of search content or user post item may produce representations of those items that have a smaller data size than input text data. In some implementations, such representations may be helpful to reduce processing cost (e.g., computational cost, memory usage, etc.) to generate an output (e.g., a label, a classification, etc.). In some implementations, such representations may be provided as input to a different machine learning application that produces output from the output of inference engine 636. In some implementations, knowledge representations generated by machine learning application 610 may be provided to a different device that conducts further processing, e.g., over a network. In such implementations, providing the knowledge representations rather than the input data may provide a technical benefit, e.g., enable faster data transmission with reduced cost.

In some implementations, a machine learning application 610 may be implemented in an offline manner. In these implementations, trained model 634 may be generated in a first stage, and provided as part of machine learning application 610. In some implementations, machine learning application 610 may be implemented in an online manner. For example, in such implementations, an application that invokes machine learning application 610 (e.g., operating system 610, search application 609, or one or more of other applications 612) may utilize an inference produced by machine learning application 610, e.g., provide the inference to a user, and may generate system logs (e.g., if permitted by the user, an action taken by the user based on the inference: or if utilized as input for further processing, a result of the further processing). System logs may be produced periodically, e.g., hourly, monthly, quarterly, etc. and may be used, with user permission, to update trained model 634, e.g., to update embeddings for trained model 634.

In some implementations, machine learning application 610 may be implemented in a manner that can adapt to particular configuration of device 600 on which the machine learning application 610 is executed. For example, machine learning application 610 may determine a computational graph that utilizes available computational resources, e.g., processor 602. For example, if machine learning application 610 is implemented as a distributed application on multiple devices, machine learning application 610 may determine computations to be carried out on individual devices in a manner that optimizes computation. In another example, machine learning application 610 may determine that processor 602 includes a GPU with a particular number of GPU cores (e.g., 1000) and implement the inference engine accordingly (e.g., as 1000 individual processes or threads).

In some implementations, machine learning application 610 may implement an ensemble of trained models. For example, trained model 634 may include a plurality of trained models that are each applicable to the same input data. In these implementations, machine learning application 610 may choose a particular trained model, e.g., based on available computational resources, success rate with prior inferences, etc. In some implementations, machine learning application 610 may execute inference engine 636 such that a plurality of trained models is applied. In these implementations, machine learning application 610 may combine outputs from applying individual models, e.g., using a voting-technique that scores individual outputs from applying each trained model, or by choosing one or more particular outputs. Further, in these implementations, machine learning application 610 may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine learning application, e.g., by operating system 610 or one or more applications 609 or 612.

In different implementations, machine learning application 610 can produce different types of outputs. For example, machine learning application 610 can provide representations or clusters (e.g., numeric representations of input data), etc. In some implementations, machine learning application 610 may produce an output based on a format specified by an invoking application, e.g., operating system 610 or one or more applications 612. In some implementations, an invoking application may be another machine learning application. For example, such configurations may be used in generative adversarial networks, where an invoking machine learning application is trained using output from machine learning application 610 and vice-versa.

Any of the software in memory 604 can alternatively be stored on any other suitable storage location or computer-readable medium. Memory 604 and any other type of storage (magnetic disk, optical disk, magnetic tape, or other tangible media) can be considered “storage” or “storage devices.”

For ease of illustration, FIG. 6 shows one block for each of processor 602, memory 604, I/O interface 606, and software blocks 608-614 and 632-636. These blocks may represent one or more processors or processing circuitries, operating systems, memories, I/O interfaces, applications, and/or software modules. In other implementations, device 600 may not have all of the components shown and/or may have other elements including other types of elements instead of, or in addition to, those shown herein. While some components are described as performing blocks and operations as described in some implementations herein, any suitable component or combination of components of environment 100, device 600, similar systems, or any suitable processor or processors associated with such a system, may perform the blocks and operations described.

Methods described herein can be implemented by computer program instructions or code, which can be executed on a computer. For example, the code can be implemented by one or more digital processors (e.g., microprocessors or other processing circuitry) and can be stored on a computer program product including a non-transitory computer-readable medium (e.g., storage medium), such as a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (Saas) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

Although the description has been described with respect to particular implementations thereof, these particular implementations are merely illustrative, and not restrictive. Concepts illustrated in the examples may be applied to other examples and implementations.

In situations in which certain implementations discussed herein may collect or use personal information about users (e.g., user data, such as user post items, context data, and other data, information about a user's social network, user's location and time at the location, user's biometric information, user's activities and demographic information), users are provided with one or more opportunities to control whether information is collected, whether the personal information is stored, whether the personal information is used, and how the information is collected about the user, stored and used. That is, the systems and methods discussed herein collect, store and/or use user personal information specifically upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity may be treated so that no personally identifiable information can be determined. As another example, a user device's geographic location may be generalized to a larger region so that the user's particular location cannot be determined.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method comprising:
inputting search content to a first content encoder to generate a first embedding that semantically represents the search content, wherein the first content encoder includes a first trained machine learning model;
inputting a plurality of user post items and a plurality of creator context data items associated with the plurality of user post items to one or more second content encoders to generate a corresponding plurality of second embeddings that semantically represent the plurality of user post items and the plurality of creator context data items, wherein the plurality of user post items originate from a plurality of creators and the plurality of creator context data items each include an indication of one or more characteristics of a creator of the plurality of creators that originated the associated user post item of the plurality of user post items, wherein the one or more second content encoders each include at least one trained second machine learning model;
determining a respective similarity measure between the first embedding and one or more of the plurality of second embeddings; and
determining and outputting a result set that includes one or more of the plurality of user post items that are associated with the respective similarity measures indicating highest similarity of respective embeddings of the plurality of second embeddings to the first embedding.

2. The computer-implemented method of claim 1, wherein the input search content is a news article that includes news text content, and the plurality of user post items are user content posts published on a social network and include post text content.

3. The computer-implemented method of claim 1, wherein the one or more characteristics of the creator for the creator context data items include at least one of: a username or identifier of the creator, biographical information of the creator, an address of a website associated with the creator, or a geographical location of the creator.

4. The computer-implemented method of claim 1, wherein the one or more second content encoders include a particular second content encoder that is trained based on training data including training user post items and associated training creator context data items, and wherein inputting the plurality of user post items and the plurality of creator context data items to the one or more second content encoders includes, for each pair of a user post item and an associated creator context data item:
concatenating the user post item and the associated creator context data item to form a concatenated content item; and
inputting the concatenated content item to the particular second content encoder to generate a respective second embedding of the corresponding plurality of second embeddings, wherein the respective second embedding is a vector representation of the user post item and the associated creator context data item.

5. The computer-implemented method of claim 1, wherein the one or more second content encoders include a user content encoder that is trained based on training user post items and a creator context encoder that is trained based on training creator context data items, and wherein inputting the plurality of user post items and the plurality of creator context data items to the one or more second content encoders includes:
for each pair of a user post item and an associated creator context data item:
inputting the user post item to the user content encoder to generate a first intermediate embedding that is a vector representation of the user post item;
inputting the creator context data item to the creator context encoder to generate a second intermediate embedding that is a vector representation of the creator context data item;
concatenating the first intermediate embedding and the second intermediate embedding to form a concatenated embedding; and
inputting the concatenated embedding to a combining neural network to generate a respective second embedding of the corresponding plurality of second embeddings.

6. The computer-implemented method of claim 1, wherein the respective similarity measure between the first embedding and each of the corresponding plurality of second embeddings is a respective resulting similarity measure, wherein the one or more second content encoders include a user content encoder that is trained based on training user post items and a creator context encoder that is trained based on training creator context data items, and
wherein inputting the plurality of user post items and the plurality of creator context data items to the one or more second content encoders includes:
for each pair of a user post item and an associated creator context data item:
inputting the user post item to the user content encoder to generate a user post embedding that is a vector representation of the user post item;
determining a first similarity measure between the user post embedding and the first embedding;
inputting the creator context data item to the creator context encoder to generate a creator context embedding that is a vector representation of the creator context data item;
determining a second similarity measure between the creator context embedding and the first embedding; and
combining the first similarity measure and the second similarity measure to form the respective resulting similarity measure.

7. The computer-implemented method of claim 1, wherein the search content is a search query, the plurality of user post items include a plurality of images or a plurality of videos posted to a social network, and each creator context data item is data describing one or more characteristics of a creator of an associated one of the plurality of images or the plurality of videos.

8. A device comprising:
a processor; and
a memory coupled to the processor, with instructions stored thereon that, when executed by the processor, cause the processor to perform operations comprising:
inputting search content to a first content encoder to generate a first embedding that semantically represents the search content, wherein the first content encoder includes a first trained machine learning model;
inputting a plurality of user post items and a plurality of creator context data items associated with the plurality of user post items to one or more second content encoders to generate a corresponding plurality of second embeddings that semantically represent the plurality of user post items and the plurality of creator context data items, wherein the plurality of user post items originate from a plurality of creators and the plurality of creator context data items each include an indication of one or more characteristics of a creator of the plurality of creators that originated the associated user post item of the plurality of user post items, wherein the one or more second content encoders each include at least one trained second machine learning model;
determining a respective similarity measure between the first embedding and one or more of the plurality of second embeddings; and
determining and outputting a result set that includes one or more of the plurality of user post items that are associated with the respective similarity measures indicating highest similarity of respective embeddings of the plurality of second embeddings to the first embedding.

9. (canceled)

10. The device of claim 8, wherein the one or more characteristics of the creator for the creator context data items include at least one of: a username or identifier of the creator, biographical information of the creator, an address of a website associated with the creator, or a geographical location of the creator.

11. The device of claim 8, wherein the one or more second content encoders include a particular second content encoder that is trained based on training data including training user post items and associated training creator context data items, and wherein the operation of inputting the plurality of user post items and the plurality of creator context data items to the one or more second content encoders includes, for each pair of a user post item and an associated creator context data item:
concatenating the user post item and the associated creator context data item to form a concatenated content item; and
inputting the concatenated content item to the particular second content encoder to generate a respective second embedding of the corresponding plurality of second embeddings, wherein the respective second embedding is a vector representation of the user post item and the associated creator context data item.

12. The device of claim 8, wherein the one or more second content encoders include a user content encoder that is trained based on training user post items and a creator context encoder that is trained based on training creator context data items, and wherein the operation of inputting the plurality of user post items and the plurality of creator context data items to the one or more second content encoders includes:
for each pair of a user post item and an associated creator context data item:
inputting the user post item to the user content encoder to generate a first intermediate embedding that is a vector representation of the user post item;
inputting the creator context data item to the creator context encoder to generate a second intermediate embedding that is a vector representation of the creator context data item;
concatenating the first intermediate embedding and the second intermediate embedding to form a concatenated embedding; and
inputting the concatenated embedding to a combining neural network to generate a respective second embedding of the corresponding plurality of second embeddings.

13. The device of claim 8, wherein the respective similarity measure between the first embedding and each of the corresponding plurality of second embeddings is a respective resulting similarity measure, wherein the one or more second content encoders include a user content encoder that is trained based on training user post items and a creator context encoder that is trained based on training creator context data items, and
wherein the operation of inputting the plurality of user post items and the plurality of creator context data items to the one or more second content encoders includes:
for each pair of a user post item and an associated creator context data item:
inputting the user post item to the user content encoder to generate a user post embedding that is a vector representation of the user post item;
determining a first similarity measure between the user post embedding and the first embedding;
inputting the creator context data item to the creator context encoder to generate a creator context embedding that is a vector representation of the creator context data item;
determining a second similarity measure between the creator context embedding and the first embedding; and
combining the first similarity measure and the second similarity measure to form the respective resulting similarity measure.

14. The device of claim 8, wherein the search content is a search query, the plurality of user post items include a plurality of images or a plurality of videos posted to a social network, and each creator context data item is data describing one or more characteristics of a creator of an associated one of the plurality of images or the plurality of videos.

15. A non-transitory computer-readable medium with instructions stored thereon that, when executed by a processor, cause the processor to perform operations comprising:
inputting search content to a first content encoder to generate a first embedding that semantically represents the search content, wherein the first content encoder includes a first trained machine learning model;
inputting a plurality of user post items and a plurality of creator context data items associated with the plurality of user post items to one or more second content encoders to generate a corresponding plurality of second embeddings that semantically represent the plurality of user post items and the plurality of creator context data items, wherein the plurality of user post items originate from a plurality of creators and the plurality of creator context data items each include an indication of one or more characteristics of a creator of the plurality of creators that originated the associated user post item of the plurality of user post items, wherein the one or more second content encoders each include at least one trained second machine learning model;
determining a respective similarity measure between the first embedding and one or more of the plurality of second embeddings; and
determining and outputting a result set that includes one or more of the plurality of user post items that are associated with the respective similarity measures indicating highest similarity of respective embeddings of the plurality of second embeddings to the first embedding.

16. (canceled)

17. The non-transitory computer-readable medium of claim 15, wherein the one or more characteristics of the creator for the creator context data items include at least one of: a username or identifier of the creator, biographical information of the creator, an address of a website associated with the creator, or a geographical location of the creator.

18. The non-transitory computer-readable medium of claim 15, wherein the one or more second content encoders include a particular second content encoder that is trained based on training data including training user post items and associated training creator context data items, and wherein the operation of inputting the plurality of user post items and the plurality of creator context data items to the one or more second content encoders includes, for each pair of a user post item and an associated creator context data item:
concatenating the user post item and the associated creator context data item to form a concatenated content item; and
inputting the concatenated content item to the particular second content encoder to generate a respective second embedding of the corresponding plurality of second embeddings, wherein the respective second embedding is a vector representation of the user post item and the associated creator context data item.

19. The non-transitory computer-readable medium of claim 15, wherein the one or more second content encoders include a user content encoder that is trained based on training user post items and a creator context encoder that is trained based on training creator context data items, and wherein the operation of inputting the plurality of user post items and the plurality of creator context data items to the one or more second content encoders includes:
for each pair of a user post item and an associated creator context data item:
inputting the user post item to the user content encoder to generate a first intermediate embedding that is a vector representation of the user post item;
inputting the creator context data item to the creator context encoder to generate a second intermediate embedding that is a vector representation of the creator context data item;
concatenating the first intermediate embedding and the second intermediate embedding to form a concatenated embedding; and
inputting the concatenated embedding to a combining neural network to generate a respective second embedding of the corresponding plurality of second embeddings.

20. The non-transitory computer-readable medium of claim 15, wherein the respective similarity measure between the first embedding and each of the corresponding plurality of second embeddings is a respective resulting similarity measure, wherein the one or more second content encoders include a user content encoder that is trained based on training user post items and a creator context encoder that is trained based on training creator context data items, and
wherein the operation of inputting the plurality of user post items and the plurality of creator context data items to the one or more second content encoders includes:
for each pair of a user post item and an associated creator context data item:
inputting the user post item to the user content encoder to generate a user post embedding that is a vector representation of the user post item;
determining a first similarity measure between the user post embedding and the first embedding;
inputting the creator context data item to the creator context encoder to generate a creator context embedding that is a vector representation of the creator context data item;
determining a second similarity measure between the creator context embedding and the first embedding; and
combining the first similarity measure and the second similarity measure to form the respective resulting similarity measure.

21. The computer-implemented method of claim 1, wherein the user post items exclude post items created by a user that provides the search content.

22. The computer-implemented method of claim 1, further comprising:
determining clusters of creator context for the plurality of creators based on similarity of the creators to topics and indexing the clusters with associated user post items of the plurality of user post items;
prior to inputting the plurality of user post items to the one or more second content encoders, selecting the plurality of user post items to be input to the one or more second content encoders based on the plurality of user post items being associated with creators having topic authority for one or more topics included in the search content, wherein the creators having topic authority are determined based on the clusters.
